(19) United States
(12) Patent Application Publication
(10) Pub. No.: US 2007/0106005 A1
(43) Pub. Date: May 10, 2007

(54) Methods for intercalating, exfoliating and/or dispersing clay particles, and articles incorporating such clay particles

(75) Inventor: Philip D. Bourgeois, Red Lion, PA (US)

Correspondence Address: RISSMAN JOBSE HENDRICKS & OLIVERIO, LLP, ONE STATE STREET, SUITE 800, BOSTON, MA, 02109, US

(73) Assignee: Graham Packaging PET Technologies Inc., York, PA (US)

(21) Appl. No.: 11/272,315

(22) Filed: Nov. 10, 2005

(51) Int. Cl. C08K 9/04

(52) U.S. Cl. 524/445

(57) ABSTRACT

Methods are provided for intercalating, exfoliating and/or dispersing clay particles with a cationic polymer for form clay nanoparticles. The resulting clay nanoparticles may be incorporated in various polymeric articles, such as a container, preform, closure, liner, sheet or film.

### FIELD OF THE INVENTION

The invention relates generally to clay particles which may be useful for enhancing certain properties (e.g., gas barrier) of polymeric articles. In various embodiments, the invention provides methods for intercalating, exfoliating and/or dispersing clay particles and their subsequent use in various monolithic and multilayer plastic articles.

### BACKGROUND

Clay particles are commercially available as stacked thin wafer-like sheets held together through ionic interactions mediated by cations such as sodium or calcium ions. Typically the sheets have negatively charged faces and slight positive charges at the edges. They have been used in various articles to provide gas barrier properties, e.g. for oxygen O₂ and/or carbon dioxide CO₂.

For use in the manufacture of an article such as a plastic bottle or container, the wafers may be separated into single sheets. Previously this has been done by first dispersing the particles in water, which causes the sheets to swell and separate and causes the cations to be solvated away. Small molecules such as quarternary ammonium salts, maleic acid and sulphonic acid and their salts are then added to serve as the intercalating and exfoliating agents. The small molecules typically form an oxonium ion with the clay particle. After the small molecules are added the water is removed leaving the exfoliated clay nanoparticles.

The small molecules that are used as intercalating and exfoliating agents have various shortcomings, such as limited thermal processability and stability, limited ability to act as both a compatibilizing agent and a dispersing agent, and limited ability to tether between the nanoparticle and a polymer matrix to which they may be added. Moreover, the water removal step, necessary when salts are used, may be time consuming. A need therefore exists to provide improved intercalating, exfoliating and/or dispersing agents that are suitable for use with clay particles. A need also exists for a more efficient method of intercalating, exfoliating and/or dispersing clay particles, particularly in a polymer material.

### SUMMARY OF THE INVENTION

Certain embodiments of the invention provide a method of intercalating and exfoliating a clay particle comprising mixing the clay particle under shear conditions with a cationic polymer such that the clay particle is intercalated and exfoliated to form clay nanoparticles. Further embodiments of the invention provide a method of mixing the intercalated and exfoliated clay nanoparticles with another material, such as another polymer material. Other embodiments provide a barrier polymer composition including intercalated, exfoliated and dispersed clay nanoparticles and a cationic polymer. Still further embodiments provide a method of making an article that includes the clay nanoparticle/cationic polymer mixture alone or in combination with one or more other materials.

In one embodiment, the clay (e.g. montmorillinite) is intercalated and exfoliated in a mixture with a polyamine such as polyethyleneimine (PEI). The resulting clay nanoparticles and PEI can then be mixed with polyethylene vinyl alcohol copolymer (EVOH) or other gas barrier materials and incorporated into a monolithic structure or one or more layers of a multilayer structure. The mixture of nanoclay/PEI/EVOH may increase the gas barrier and/or physical properties of the material, especially under conditions of high humidity and/or high temperature.

In accordance with another embodiment, the clay particle is mixed under shear conditions with polyamine (as the cationic polymer). This mixing may be performed at room temperature or above. The shear conditions may comprise mixing the polyamine with the clay particle in an agitator, homogenizer, or extruder. The resulting intercalated and exfoliated nanoparticles may be mixed with a polymer material and/or a barrier material and used to form all or part of a monolithic or multilayer article. The polymer material may be one or more of polyester, polyolefin, polyamide, and copolymers and blends thereof. The barrier material may be one or more of polyalcohol, polyamide, polyglycolic acid, acrylonitrile copolymer, cyclic olefin copolymer, polyvinylidene chloride, and copolymers and blends thereof.

In a further embodiment, a composition is made by a process comprising:
a) mixing the clay particle with a cationic polymer under shear conditions such that the clay particle is intercalated and exfoliated with the cationic polymer to form clay nanoparticles; and b) blending the clay particle mixture with at least one of a barrier material and a polymer material to form a composition of clay nanoparticles dispersed in the material.

In yet another embodiment, a barrier composition is provided which includes the clay nanoparticles and cationic polymer in combination with one or more barrier materials.

These and other embodiments and features of the present invention are described in the following detailed description.

### DETAILED DESCRIPTION

Clay particles are useful for enhancing the gas barrier properties of a variety of manufactured articles, such as blow-molded plastic containers and preforms for making such containers. In most cases, only small amounts of clay are required to provide an adequate gas barrier. Clay particles are commercially available in agglomerated stacked sheets, but these are generally not suitable for use in many manufactured articles where only small quantities are required. Moreover, large agglomerates of clay may be detrimental to the aesthetics and physical attributes of the article, e.g., transparency of a molded plastic beverage bottle.

One embodiment of the invention thus provides a method of intercalating, exfoliating and dispersing a clay particle which is then suitable for use as a gas barrier in an article. In certain embodiments, the intercalating, exfoliating and dispersing agent is a polymer, and in particular a cationic polymer. The invention also provides a method of making an article which includes the intercalated, exfoliated, and dispersed clay nanoparticles in at least a portion of the article, such as in one or more layers of a multilayer article. After intercalating and exfoliating, the clay particle comprises clay nanoparticles.

A. Definitions

Intercalate refers to the ability of an agent, e.g. a foreign molecule, or a part of a foreign molecule, to wedge or insert itself between the layers (e.g. stacked sheets) of a multilayer material. The agent may cause the multilayer material to swell.

Exfoliate refers to the separation of individual layers of a multilayer material into a disordered structure without any substantial layered (stacking) order.

Disperse refers to the mixing of a first material which has undergone intercalation and exfoliation with a second material (e.g. a polymer), to form a substantially uniform dispersion of the first material with respect to the second material.

Shear conditions refer to physical force or agitation applied to a material, e.g., a clay particle, such that the material substantially separates into single layers (sheets).

Nanoparticle refers to a particle having at least one dimension in the nanometer range. For a single layer sheet of such particles, the flat face (lateral plane) of such a nanoparticle sheet would generally have at least one dimension in a range of about 3-700 nanometers (nm), more preferably 3-500 nm, and still more preferably 3-50 nm.

Regrind is ground up material made from, for example: the manufacturing scrap resulting from the molding of containers, preforms, or other articles; articles which fail to meet manufacturing specifications; and post-consumer or recycled articles. The ground up material is typically provided as granules or flake (referred to as regrind), which is then remelted and extruded to make new articles.

B. Clay Particles

Clay particles may be used as gas or liquid barriers in various articles of manufacture. The clay particles may be used to reduce the rate at which one or more gases or liquids permeate through the article, in order to reduce/prevent the gases or liquid from penetrating to the interior of an article, or reduce/prevent the gases or liquids contained within the article (e.g. CO₂ in a carbonated beverage) from penetrating to the exterior of (leaving) the article, or both. Clay particles may provide a suitable barrier for any gas, such as oxygen (O₂) and/or carbon dioxide (CO₂), or for various organic liquids or solvents, such as gasoline or motor oil.

Clay minerals primarily comprise hydrated silicates of aluminum (Al₂O₃SiO₂.xH₂O). Suitable clay particles for use in this invention may include for example phyllosilicate, montmorillonite, sodium montmorillonite, magnesium montmorillonite, calcium montmorillonite, nontronite, beidellite, volkonskoite, hectorite, saponite, sauconite, sobockite, stevensite, svinfordite, vermiculite, magadiite, kenyaite, talc, mica, kaolinite, and mixtures thereof. Other useful layered materials include illite, mixed layered illite/smectite minerals, such as ledikite, and admixtures of illites with the clay minerals named above. Other useful layered materials may include the layered double hydroxides or hydrotalcites. Other useful clays include magnesium aluminum silicate. The aforementioned clays can be natural or synthetic, for example synthetic smectite clay may be used. Preferred is the phyllosilicate subclass, having a sheet like structure and in particular the montmorillonite group comprising hydrated aluminum magnesium silicate [K⁺_{0.58}(Al, Mg)₂(Si,Al)₄O₁₀(OH)₂]. Interlayer water or cation exchange occurs readily in the montmorillonite group, with accompanying changes in the c-dimension and hence their being known as “swelling clays.” All of the aforementioned materials are included in the term clay particle as used herein.

C. Intercalating, Exfoliating and/or Dispersing Agents

In certain embodiments, the invention provides agents suitable for intercalating, exfoliating and/or dispersing a layered (sheet-like) material such as clay. A single agent may perform all three functions. The agent is a cationic polymer, such as a polyamine, which may function as a weak Lewis base in aqueous environments. Preferably, the polymer has a high cationic charge density of at least 10 milliequivalents per gram and more particularly at least 15 milliequivalents per gram. One particular example comprises polyethyleneimine (PEI) having a charge density of about 20 milliequivalents per gram. The polymer may have a viscosity in the range of about 10 centipoise to about 250,000 centipoise as measured at 25° C. In some embodiments the polymer has a viscosity in a range of about 2500 centipoise to about 8500 centipoise. The skilled artisan will will lower the viscosity. The polymer may have a number average molecular weight in the range of 300-60,000. In some embodiments the molecular weight is about 1200. In one embodiment, the cationic polymer is a polyamine, and more particularly a polyalkylene amine. In select embodiments, it is a polyimine, preferably a polyalkylene imine, and more preferably a polyethyleneimine.

Preferably, the agent will achieve a substantially complete interacalation and exfoliation of the agglomerated clay particle into clay nanoparticles; in select embodiments the extent (volume percentage) of the intercalated and exfoliated clay nanoparticles comprises at least 50%, more preferably at least 75%, and still more preferably at least 90% of the clay in the agent/clay mixture.

In some embodiments the agent may be a polyamine comprised of primary, secondary and tertiary amine groups. The primary, secondary and tertiary amine groups may be present in a ratio of about 1:2:1. The polyamine may be comprised of repeating chemical units denoted as —(CH₂—CH₂—NH)—. In certain embodiments the agent is polyethyleneimine (PEI), which may be produced by ring opening polymerization of ethyleneimine using an acid catalyst as shown below:

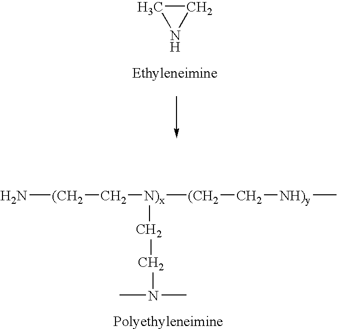

PEI is available commercially, e.g., EPOMIN (Nippon Shokubai Co., Ltd, Kawasaki, Japan), and Luprasol® (BASF Corporation, Rensselaer, N.Y.). PEI's are highly charged cationic polymers due to the abundance of primary, secondary and tertiary amino groups, which provide good interaction with the polar nature of nanoclays (nanoparticle clays). Also, their low viscosity, compared to the melt viscosities of other polymers, enables one to achieve (through shear mixing) a high degree of exfoliation and dispersion of the nanoclay into a liquid PEI matrix which can then be introduced into a melt stream of for example, EVOH, polyamides or other polymers.

D. Articles

In certain embodiments, the invention provides for intercalating, exfoliating and dispersing the nanoparticle clay in a polymer material or barrier material as part of a monolithic or multilayered article. The dispersed nanoparticle clay may enhance the gas barrier and/or physical properties of the article. Thus in certain embodiments where intercalated, exfoliated and dispersed nanoclay particles are mixed throughout an article, the article may be more resistant to penetration by oxygen from the environment (exterior of the container) into the interior of the container. Similarly, the gas barrier may inhibit or prevent loss of a gas, such as carbon dioxide, from the interior of the container to the surrounding environment. The gas barrier may thus be used in containers for carbonated beverages, such as beer, soda or carbonated water, and for juice, sauces and condiments. Preferably, the nanoclay particles can be added to the gas barrier material without loss of transparency in applications where a transparent container or other article is desirable.

The article may be for example a container, preform, closure, liner, sheet or film. The container may be one that is used to contain liquid, e.g., a beverage such as a carbonated beverage and/or an oxygen-sensitive beverage. The container may also be used to contain organic liquids and solvents such as motor oil or gasoline; in this later capacity the barrier property enhanced by the clay nanoparticle mixture may be as a barrier to liquids or solvents.

The article may be a monolithic structure such as a molded article, film or sheet. A monolithic structure is one that is made of a substantially uniform material or a substantially uniform blend of materials. The article, film or sheet can be used in any product in which enhanced gas or liquid barrier properties are desirable, e.g. a fuel hose.

The article may be a multilayer article comprised of at least two layers. Multilayer articles may be comprised of one or more polymer (e.g. structural) material layers alternating with one or more barrier material layers. The multilayer article may also contain an adhesion-promoting material which may be blended with the polymer material, the barrier material, or both, or the adhesion-promoting material may be provided as a separate layer. In some embodiments, the same cationic polymer may serve to intercalate, exfoliate and disperse the nanoclay particles and also to adhere multiple layers of the article. Thus, the cationic polymer may also provide delamination resistance to the multilayer article. In certain embodiments, the multilayer article may include a barrier layer sandwiched in between two polymer layers. In other embodiments the multilayer article may be comprised of five alternating layers, e.g., three polymer layers and two barrier layers, where each of the barrier layers is disposed between two polymer layers. The various layers may extend throughout the article and/or be confined to only a portion of the article. As an example, where the article is a container, the barrier layer may extend throughout the container, or be confined to the sidewall, the base, the neck, the finish, or any combination thereof.

Any known polymer material may be used. In certain embodiments, the polymer has at least one ester functional group. The ester group may be in the main chain of the polymer, i.e., the longest chain of the polymer, or in a branch off the main chain of the polymer, i.e., a chain chemically bonded to, or associated with, the main chain of the polymer. In certain embodiments the polymer is a polyester. Suitable ester containing polymers include polyethylene terephthalate (PET), polybutylene terephthalate (PBT), polypropylene terephthalate (PPT), polyethylene naphthalate (PEN), polylactic acid (a.k.a. polylactide) (PLA), and polytrimethylene naphthalate (PTN). Other suitable matrix polymers include polyacrylates, such as polymethyl methacrylate (PMMA) and polyethylene methacrylate (PEMA), vinyl acetates, polyolefins, polypropylene, polyethylene, polyamides, polyglycolic acid (PGA), and polycarbonate. Blends and/or copolymers of any of the aforementioned polymers may also be suitable. Regrinds of any of the aforementioned may also be suitable. The intercalated and exfoliated clay nanoparticles may be dispersed throughout any of the polymers described herein.

Any known barrier material may be used. In some embodiments, the barrier may comprise a polyalcohol, e.g. polyethylene vinyl alcohol copolymer (EVOH), an olefin, e.g. a cyclic olefin copolymer, a polyamide, e.g. meta-xylylenediamine (MXD) or nylon-6, a thermoplastic polymer, e.g., ionomer, a hetero-alkene, e.g. acrylonitrile, a halo-alkene, a polyglycolic acid, or polyvinylidene chloride (PVDC). The barrier may be an active barrier (e.g., any of the known oxygen-scavenging barrier compositions, such as Amosorb, polyamide and transition metal), a passive barrier (e.g., EVOH), or a combination of both. The invention also contemplates using copolymers and/or blends of any of the aforementioned barrier materials, and regrinds of any barrier materials. The intercalated and exfoliated clay nanoparticles may be dispersed throughout any of the barrier materials described herein.

E. Methods of Making Articles with Improved Gas Barrier Properties

Certain embodiments of the invention provide a method of making an article having improved gas barrier properties. The method comprises intercalating, exfoliating, and dispersing a clay particle with a cationic polymer to form clay nanoparticles and dispersing the clay nanoparticles and cationic polymer mixture throughout at least a portion of an article. The clay particle may be intercalated, exfoliated, and dispersed under shear conditions. Shear conditions may include mixing a clay particle and a cationic polymer, e.g., PEI, in an agitator, mixing a clay particle and a cationic polymer in a homogenizer, or adding a clay particle to a molten phase comprising a cationic polymer and a barrier resin in an extruder.

Any of the steps of intercalating, exfoliating and dispersing may be performed at about room temperature. In some embodiments, one or more of these steps may be performed at elevated temperatures, e.g., above 20° C. In other embodiments, one or more of these steps may be performed at temperatures in a range from about 15° C. to about 300° C. Elevating the temperature may decrease the viscosity of the cationic polymer thereby facilitating the intercalation, exfoliation and dispersal of the clay particle. Lowering the temperature, after the clay particle has been intercalated, exfoliated, and dispersed, may facilitate maintaining clay nanoparticles. As the temperature of the cationic polymer is decreased its viscosity increases, thus assisting in preventing the clay particles from agglomerating together to reform their original wafer-like structure. The inhibition of reformation of agglomerated clay particles is also referred to as compatibilizing the clay particle and results not only from the viscosity of the cationic polymer, but from charge-charge interactions, such as dipole-dipole interactions or acid-base interactions, between the clay particle and the cationic polymer. The clay nanoparticles may be mixed with the cationic polymer in a range of for example about 0.5 to about 30 weight percent of the clay nanoparticles in the mixture, more particularly about 0.5 to about 25 weight percent, and still more particularly about 0.5 to about 20 weight percent.

In some embodiments, after the clay particle is intercalated, exfoliated and dispersed with the cationic polymer, the mixture may be used to form at least a portion of an article, e.g. a multi-layer article. The mixture may be also blended before being used to form an article. Where the article is a multilayer article, the nanoclay/cationic polymer mixture may comprise or be blended with at least one of the layers. The cationic polymer may serve to intercalate, exfoliate and disperse the clay particle. The cationic polymer may also provide adhesion-promoting properties and thus inhibit delamination where the article is comprised of a plurality of layers.

The clay nanoparticles may be present in a range of for example about 0.05 to about 5 weight percent of the mixture of polymer (or barrier) material including the clay particles, more particularly about 0.1 to about 4 weight percent, and still more particularly about 0.1 to about 2.5 weight percent. The polymer (or barrier) material including the clay particles may then be provided in one or more layers in a multilayer article in a range of for example about 1 to about 5 weight percent of the article, more particularly about 1.5 to about 4 weight percent, and still more particularly about 2 to about 3 weight percent.

In one embodiment, a clay particle (agglomerated) may be combined with PEI under shear conditions. The PEI may be at room temperature or above, and thus comprise a viscous liquid. The viscosity will depend on the temperature and molecular weight of the PEI. The PEI may have a number average molecular weight from about 300 to about 10,000, and may comprise about 35% primary amines, about 35% secondary amines and about 30% tertiary amine groups. After the clay particle is substantially intercalated and exfoliated the mixture may be used to form a multilayer article for example such that the final concentration of the PEI/clay nanoparticle mixture is about 2 weight percent of a barrier layer within article. In this example the PEI serves to intercalate, exfoliate and disperse the clay nanoparticles, and may also serve as an adhesion-promoting layer which prevents delamination of the multilayer article. The multilayer article includes one or more layers of a polymer matrix resin, such as a polyester (e.g. PET), and at least one layer of a barrier polymer resin, such as an alcohol (e.g. EVOH). The article may be a preform or a plastic container. Various multilayered articles and methods of making such multilayer articles have been described in U.S. Pat. Nos. 4,550,043; 4,609,516; 4,710,118; 4,954,376 and in U.S. patent application Ser. No. 10/688,432, filed Oct. 16, 2003 (published US2005/0084635 on Apr. 21, 2005), which are hereby incorporated by reference in their entirety.

In certain applications, it is desirable to provide a substantially transparent article. In these applications, the clay nanoparticles are preferably smaller than the wavelength of visible light. The allowable size of the clay nanoparticles will depend on their concentration in the article, and the thickness of the article and/or layer(s) which include the clay nanoparticles. One measure of transparency is the percent haze for transmitted light through the wall (H_{T}) which is given by the formula:
H_{T}=[Y_{d}÷(Y_{d}+Yₛ)]×100
where Y_{d} is the diffuse light transmitted by the specimen, and Yₛ is the specular light transmitted by the specimen. The diffuse and specular light transmission values are measured in accordance with ASTM Method D 1003, using any standard color difference meter such as model D25D3P manufactured by Hunterlab Inc. Preferably, a substantially transparent article, such as a beverage container, would have a percent haze through the sidewall of less than about 15%, and more preferably less than about 10%.

Modifications and variations of this invention will be apparent to those skilled in the art. The specific embodiments described herein are by way of example only and are not meant to be limiting in any way. It is intended that the specification and examples be considered as exemplary only, with a true scope of the invention being indicated by the following claims.

1. A method comprising mixing a clay particle under shear conditions with a cationic polymer such that the clay particle is intercalated and exfoliated to form clay nanoparticles.

2. The method of claim 1, wherein the cationic polymer comprises one or more of polyamine, polyalkylene amine, polyimine, polyalkylene imine, and polyethyleneimine.

3. The method of claim 2, wherein the cationic polymer comprises polyalkylene amine.

4. The method of claim 1, wherein the clay nanoparticles have a lateral plane dimension in a range of about 3 to 700 nm.

5. The method of claim 4, wherein the range is about 3 to 500 nm

6. The method of claim 5, wherein the range is about 3 to 50 nm

7. The method of claim 1, wherein the clay particle comprises one or more of phyllosilicate, montmorillonite, sodium montmorillonite, magnesium montmorillonite, calcium montmorillonite, nontronite, beidellite, volkonskoite, hectorite, saponite, sauconite, sobockite, stevensite, svinfordite, vermiculite, magadiite, kenyaite, talc, mica, kaolinite, and mixtures thereof.

8. The method of claim 1, wherein the cationic polymer has a charge density of at least 10 milliequivalents per gram.

9. The method of claim 1, wherein the cationic polymer has a viscosity in a range of about 2500 centipoise to about 8000 centipoise.

10. The method of claim 2, wherein the clay nanoparticles are present in a range of about 0.5 to about 30 percent by weight of the total weight of the mixture.

11. The method of claim 1, wherein the shear conditions comprise mixing the cationic polymer with the clay particle in one or more of an agitator, a homogenizer and an extruder.

12. The method of claim 1, wherein the clay nanoparticles and cationic polymer mixture is mixed with a barrier material.

13. The method of claim 12, wherein the barrier material comprises one or more of an active barrier and a passive barrier.

14. The method of claim 12, wherein the barrier material comprises one or more of polyalcohol, polyamide, polyglycolic acid, acrylonitrile copolymer, cyclic olefin copolymer and copolymer and blends thereof.

15. The method of claim 14, wherein the barrier material comprises polyethylene vinyl alcohol copolymer.

16. The method of claim 15, wherein the polyethylene vinyl alcohol copolymer is blended with one or more of an ionomer, acrylonitrile, cyclic olefin copolymer, polyglycolic acid, and polyvinylidene chloride.

17. The method of claim 12, wherein the barrier material comprises a blend of polyester and polyamide.

18. The method of claim 12, wherein the barrier material mixture is formed into a monolithic article.

19. The method of claim 12, wherein the barrier material mixture is formed into a multilayer article.

20. The method of claim 13, wherein the barrier material mixture is formed into at least a portion of a container, preform, closure, liner, sheet or film.

21. The method of claim 1, wherein the clay nanoparticles and cationic polymer mixture is mixed with a polymer material.

22. The method of claim 21, wherein the polymer material comprises one or more of polyester, polyolefin, polyamide and copolymers and blends thereof.

23. The method of claim 22, wherein the polymer material comprises an ester containing polymer.

24. The method of claim 23, wherein the ester containing polymer comprises one or more of PET, PEN, PBT, PPT, PLA, PTN and copolymers and blends thereof.

25. The method of claim 21, wherein the polymer material mixture is formed into at least a portion of a container, preform, closure, liner, sheet or film.

26. The method of claim 1, wherein the cationic polymer has a charge density of at least 10 milliequivalents per gram and a viscosity in a range of about 2500 centipoise to about 8000 centipoise, and the clay nanoparticles are present in a range of about 0.5 to about 30 percent by weight of the total weight of the mixture.

27. The method of claim 1, wherein the clay particle is mixed with the cationic polymer a temperature range of about 15° C to about 300° C.

28. An article made by a process comprising:
a) mixing a clay particle with a cationic polymer under shear conditions such that the clay particle is intercalated, exfoliated and dispersed as clay nanoparticles with the cationic polymer; and
b) mixing the clay nanoparticles and cationic polymer mixture with at least one of a barrier material and a polymer material to form at least a portion of an article.

29. The article of claim 28, wherein the cationic polymer comprises one or more of polyamine, polyalkylene amine, polyimine, polyalkylene imine, and polyethyleneimine.

30. The article of claim 29, wherein the cationic polymer comprises polyalkylene amine.

31. The article of claim 28, wherein the clay nanoparticles have a lateral plane dimension in a range of about 3 to 700 nm.

32. The article of claim 31, wherein the range is about 3 to 500 nm.

33. The article of claim 32, wherein the range is about 3 to 50 nm.

34. The article of claim 28, wherein the clay particle comprises one or more of phyllosilicate, montmorillonite, sodium montmorillonite, magnesium montmorillonite, calcium montmorillonite, nontronite, beidellite, volkonskoite, hectorite, saponite, sauconite, sobockite, stevensite, svinfordite, vermiculite, magadiite, kenyaite, talc, mica, kaolinite, and mixtures thereof.

35. The article of claim 34, wherein the clay particle comprises phyllosilicate.

36. The article of claim 28, wherein the article comprises a container, preform, closure, liner, sheet or film.

37. The article of claim 28, wherein the article comprises a multilayer article.

38. The article of claim 37, wherein the multilayer article comprises a container, preform, closure, liner, sheet or film.

39. The article of claim 28, wherein the polymer material comprises one or more of polyester, polyolefin, polyamide and copolymers and blends thereof.

40. The article of claim 28, wherein the polymer material comprises an ester containing polymer.

41. The article of claim 40, wherein the ester containing polymer comprises one or more of PET, PEN, PBT, PPT, PLA, PTN and copolymers and blends thereof.

42. The article of claim 28, wherein the barrier material comprises one or more of polyalcohol, polyamide, polyglycolic acid, acrylonitrile copolymer, cyclic olefin copolymer, and copolymers and blends thereof.

43. The article of claim 42; wherein the barrier material comprises polyethylene vinyl alcohol copolymer.

44. The article of claim 28, wherein the barrier material comprises a blend of polyester and polyamide.

45. A composition comprising intercalated, exfoliated and dispersed clay nanoparticles and a cationic polymer in a barrier polymer material.

46. The composition of claim 45, wherein the clay nanoparticles comprise one or more of phyllosilicate, montmorillonite, sodium montmorillonite, magnesium montmorillonite, calcium montmorillonite, nontronite, beidellite, volkonskoite, hectorite, saponite, sauconite, sobockite, stevensite, svinfordite, vermiculite, magadiite, kenyaite, talc, mica, kaolinite, and mixtures thereof

47. The composition of claim 46, wherein the cationic polymer comprises one or more of polyamine, polyalkylene amine, polyimine, polyalkylene imine, and polyethyleneimine.

48. An article comprising a barrier polymer material, the barrier polymer material including intercalated, exfoliated and dispersed clay nanoparticles and a cationic polymer.

49. The article of claim 48, wherein the article is a multilayer article and the barrier polymer material comprises at least one layer of the article.

50. The article of claim 48, wherein the article is a container, preform, closure, liner, sheet, or film.

51. The article of claim 50, wherein the article is substantially transparent.

52. The article of claim 48, wherein the article is a blow-molded thermoplastic beverage container.

53. The article of claim 48, wherein:
the barrier polymer material comprises one or more of polyalcohol, polyamide, polyglycolic acid, acrylonitrile copolymer, cyclic olefin copolymer, polyester, polyolefin, polyamide and copolymers and blends thereof;
the clay nanoparticles comprise one or more of phyllosilicate, montmorillonite, sodium montmorillonite, magnesium montmorillonite, calcium montmorillonite, nontronite, beidellite, volkonskoite, hectorite, saponite, sauconite, sobockite, stevensite, svinfordite, vermiculite, magadiite, kenyaite, talc, mica, kaolinite, and mixtures thereof; and
the cationic polymer comprises polyalkylene amine.

54. The article of claim 48, wherein the article is a multilayer article including one or more internal layers of the barrier polymer material.

55. The article of claim 54, wherein the multilayer article includes an internal layer of the barrier polymer material and external layers of another polymer material.

56. The article of claim 55, wherein the internal layer comprises polyethylene terephthalate (PET) with the clay nanoparticles and cationic polymer, and the external layers comprise PET.

57. The article of claim 56, wherein the PET in the internal layer comprises regrind PET.

58. The article of claim 54, including a core internal layer, external layers of another polymer material, and at least two intermediate internal layers of the barrier polymer material disposed on opposite sides of the core layer.

59. The article of claim 58, wherein the external and core layers comprise PET.

60. The article of claim 59, wherein the core layer comprises regrind PET.

61. The article of claim 58, wherein the core layer comprises PET with the clay nanoparticle and cationic polymer.

62. The article of claim 48, wherein the article is a container for organic liquids or solvents.

63. The article of claim 48, wherein the article is a gas barrier container for beverages.

64. The article of claim 48, wherein the article includes polyolefin.

65. The article of claim 64, wherein the barrier polymer material includes ethylene vinyl alcohol copolymer.

66. The article of claim 50, wherein the article is a monolithic article and the barrier polymer material is polyethylene vinyl alcohol copolymer.

67. The article of claim 48, wherein the article is a monolithic film.
